(19) United States
(12) Patent Application Publication
(10) Pub. No.: US 2017/0054662 A1
(43) Pub. Date: Feb. 23, 2017

(54) SYSTEMS AND METHODS FOR FACILITATING GAMEPLAY WITHIN MESSAGING FEEDS

(71) Applicant: DISNEY ENTERPRISES, INC., Burbank, CA (US)

(72) Inventors: John Crocker, Valencia, CA (US); Orrin Shively, Glendale, CA (US); David Markowitz, Thousand Oaks, CA (US); Corey Drake, Sunland, CA (US); Elvis Arevalo, Los Angeles, CA (US)

(73) Assignee: DISNEY ENTERPRISES, INC.

(21) Appl. No.: 14/832,663

(22) Filed: Aug. 21, 2015

(51) Int. Cl. H04L 12/58; G06F 3/0481

(52) U.S. Cl. CPC H04L 51/046; H04L 51/063; G06F 3/04817

(57) ABSTRACT

Systems and methods for facilitating gameplay within messaging feeds of a messaging application are described herein. A computing platform may be configured to present a messaging interface. The messaging interface may include a communication field displaying a messaging feed that reflects a communication session between the computing platform and one or more other computing platforms. Entry and/or selection of a game icon may effectuate presentation of a corresponding game within the messaging feed of the computing platform and/or other messaging feeds of the other computing platforms.

### FIELD OF THE DISCLOSURE

This disclosure relates to facilitating gameplay within messaging feeds.

### BACKGROUND

Contemporary messaging applications may allow computing platforms to send and receive messaging content in accordance with a communication session. Messaging content may appear within messaging feeds presented in messaging interfaces displayed at respective computing platforms. Messaging content sent by different users may appear in corresponding “chat bubbles” presented within a messaging feed, and/or may be distinguished from each other in other ways.

Messaging content may include graphical icons. Graphical icons may include one or more of emoticons, emojis, stickers, and/or other graphical icons. Users may add graphical icons to a messaging feed to share with other users. Graphical icons may be static or dynamic. For example, a dynamic icon may become briefly animated in a messaging feed such as a smiley face winking its eye. However, the dynamic nature of a graphical icon may end after the brief animation. The dynamic icon may become a static icon displayed in a messaging feed.

When users participating in a communication session want to play a game, they may first send text messages back and forth. For example, a user may ask another user if they are free to play a game in order to coordinate their activity, or a user may send a link to a game application or website. To engage in gameplay, the users leave the messaging application and launch a gaming application.

For gaming applications that include messaging capabilities, a gaming interface and a messaging interface may be separate and distinct from each other such that a user is participating in only one or the other at a given time.

### SUMMARY

One aspect of the disclosure relates to a system for facilitating gameplay within messaging feeds of a messaging application displayed on computing platforms. The users may participate in a messaging application executed by one or both of a host server and/or a computing platform. The messaging application may facilitate communication of messaging content between computing platforms associated with a communication session.

In some implementations, individual ones of the computing platform may be configured to present a messaging interface. The messaging interface may include an entry field, a communication field, and/or other fields. The entry field may display messaging content available for entry and/or selection by a user. The communication field may display a messaging feed that reflects a communication session between a computing platform and one or more other computing platforms. By way of non-limiting example, the presentation of the messaging feed may include messaging content previously entered and/or selected by a user through the entry field and/or messaging content previously entered and/or selected by other users through other computing platforms associated with the communication session.

The system may comprise a host server including one or more physical processors configured to execute machine-readable instructions. The machine-readable instructions may include one or more of a user component, a receiving component, an updating component, a gaming component, a scoring component, and/or other components. The system may include one or more computing platforms configured to communicate with the host server over a network, such as the Internet.

The user component may be configured to access and/or manage one or more user profiles and/or user information associated with users of the computing platforms.

The receiving component may be configured to receive messaging information describing messaging content entered and/or selected by users through computing platforms associated with communication sessions. The messaging content may be entered and/or selected by users via messaging interfaces presented at the computing platforms. By way of non-limiting example, the receiving component may be configured to receive first messaging information describing first messaging content entered and/or selected by a first user through a first computing platform. The first computing platform, a second computing platform, and/or other computing platforms may be associated with a first communication session.

The updating component may be configured to effectuate updates of messaging feeds of the messaging interfaces presented on the computing platforms. The updates may be based on the received messaging information. In some implementations, the updates may correspond to presenting messaging content in the messaging feeds. By way of non-limiting example, in some implementations, the updating component may be configured to effectuate a first update of a first messaging feed presented on the first computing platform based on the received first messaging information. The first update may correspond to presenting the first messaging content in the messaging feed.

In some implementations, messaging content available for entry and/or selection by users may include game icons. In some implementations, entry and/or selection of a game icon may effectuate presentation of a corresponding game within the messaging feeds presented on computing platforms that share a communication session. In some implementations, the user may click and/or otherwise select a game icon presented in a messaging feed in order to initiate the game.

In some implementations, the gaming component may be configured to, by virtue of the first messaging content comprising a first game icon, effectuate presentation of a first game within the first messaging feed to facilitate participation by the first user in the first game. The gaming component may be configured to effectuate presentation of the first game in a second messaging feed of a second computing platform to facilitate participation by a second user in the first game. In some implementations, the first game presented on the various computing platforms may include respective instances of the first game icon.

In some implementations, messaging content available for entry and/or selection by users may include group gameplay game icons. In some implementations, entry and/or selection of a group gameplay game icon may effectuate group gameplay events between users of computing platforms that share a communication session. In some implementations, the gaming component may be configured to effectuate presentation of mini-games within the messaging feeds of individual ones of the computing platforms in accordance with group gameplay events between users. In some implementations, the outcome of group gameplay events may depend on the outcome of the mini-games played by individual ones of the users. By way of non-limiting example, the outcome of a group gameplay event may correspond to a combined outcome of individual ones of the mini-games played by individual ones of the users.

In some implementations, the scoring component may be configured to determine outcomes of group gameplay events based on outcomes of the mini-games played by individual users in a group. By way of non-limiting example, a first outcome of first group gameplay event between a first user and a second user may be determined based on an outcome of the first mini-game played by the first user and an outcome of the second mini-game played by the second user.

In some implementations, the scoring component may be configured to effectuate presentation of determined group gameplay event outcomes on the messaging feeds associated with users in the groups. By way of non-limiting example, the first outcome may be presented on a first messaging feed associated with the first user and/or a second messaging feed associated with the second user.

One aspect of the disclosure relates to non-transitory computer-readable storage media storing instructions that are executable by a computing platform including one or more physical processors. The instructions may be executable to perform a method for facilitating gameplay within a messaging feed of a messaging application.

The method may comprise the step of presenting a messaging interface on a display of a computing platform executing the instructions. The messaging interface may include an entry field, a communication field, and/or other fields. The entry field may be configured to display messaging content available for entry and/or selection by users. The communication field may be configured to display a messaging feed that reflects a communication session between the computing platform and one or more other computing platforms. The presentation of the messaging feed may include messaging content previously entered and/or selected by a first user through the entry field. The messaging feed may include messaging content previously entered and/or selected by one or more other users through the one or more other computing platforms.

The method may comprise the step of receiving entry and/or selection of messaging content by users through the entry field. By way of non-limiting example, the step may comprise receiving entry and/or selection of first messaging content by the first user through the entry field.

The method may comprise the step of updating the messaging feed in the communication field to present the messaging content entered and/or selected by the users. By way of non-limiting example, the step may comprise updating the messaging feed in the communication field to present the first messaging content.

In some implementations, the messaging content available for entry and/or selection by the users may include one or more game icons. Entry and/or selection of a game icon may effectuate presentation of a corresponding game within the messaging feed presented on the computing platform. By way of non-limiting example, by virtue of the first messaging content comprising a first game icon, the updating step may comprise presenting a first game within the messaging feed to facilitate participation by the first user in the first game. The first game in the messaging feed may comprise a first instance of the first game icon displayed in the messaging feed.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular forms of “a”, “an”, and “the” include plural referents unless the context clearly dictates otherwise.

### BRIEF DESCRIPTION OF THE DRAWINGS

FIG. 1 illustrates a system configured for facilitating gameplay within a messaging feed of a messaging application, in accordance with one or more implementations.

FIG. 2 illustrates an exemplary implementation of a server of the system of FIG.

FIG. 3 illustrates an exemplary implementation of a computing platform of the system of FIG. 1.

FIG. 4 illustrates an exemplary implementation of a first computing platform displaying a messaging interface including a communication field, an entry field, and/or other fields.

FIG. 5 illustrates an exemplary implementation of a first computing platform including a game taking place in a messaging feed displayed in a communication field.

FIG. 6 illustrates an exemplary implementation of a second computing platform displaying a messaging interface including a communication field, an entry field, and/or other fields, and including a game taking place in a messaging feed displayed in the communication field.

FIG. 7 illustrates an exemplary implementation of a first computing platform showing updates to the game taking place in the messaging feed based on control inputs entered and/or selected by a user through a second computing platform in communication with the first computing platform over a communication session.

FIG. 8 illustrates an exemplary implementation of a second computing platform showing updates to a game taking place in the messaging feed based on control inputs entered and/or selected by a user through the second computing platform.

FIG. 9 illustrates an exemplary implementation of a first computing platform including group gameplay event messaging content used to initiate a group gameplay event that take place in the messaging feed displayed in the communication field.

FIG. 10 illustrates an exemplary implementation of a first computing platform including a first mini-game taking place in a messaging feed in accordance with a group gameplay event.

FIG. 11 illustrates an exemplary implementation of a second computing platform including a second mini-game taking place in a messaging feed in accordance with a group gameplay event.

FIG. 12 illustrates an exemplary implementation of a first computing platform presenting a group gameplay event outcome in accordance with outcomes from mini-games played by users participating in a group gameplay event.

FIG. 13 illustrates a method of facilitating gameplay within a messaging feed of a messaging application, in accordance with one or more implementations.

### DETAILED DESCRIPTION

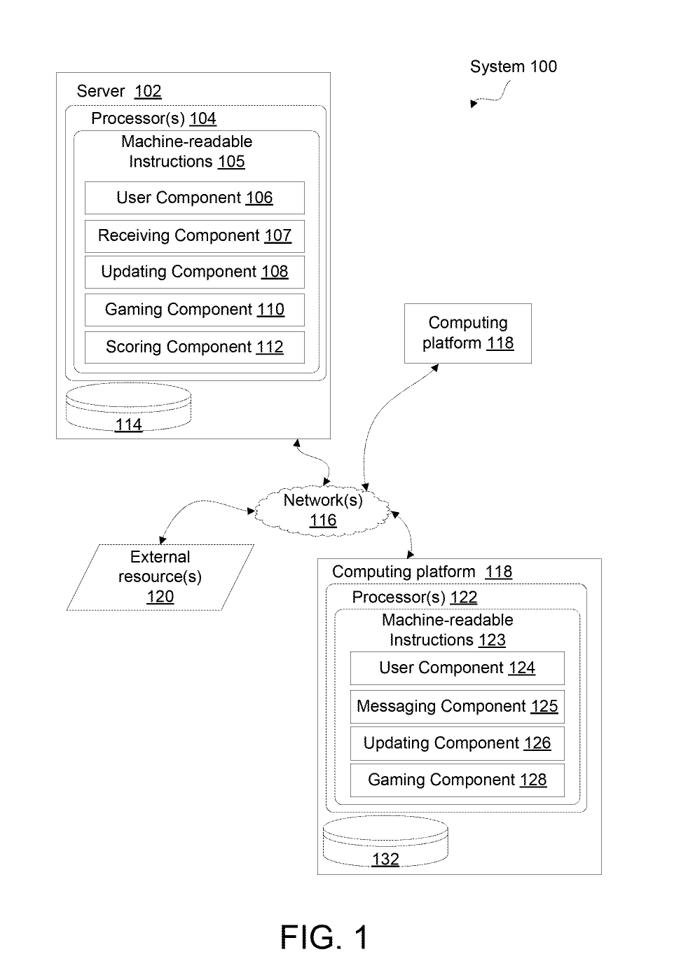

FIG. 1 illustrates a system 100 configured for facilitating gameplay within a messaging feed of a messaging application, in accordance with one or more implementations. The messaging feeds may be presented on computing platforms 118. In some implementations, communication sessions between computing platforms 118 may be established over one or more networks 116. A network 116 may include, for example, the Internet, a cellular network, local area network, and/or other networks. In some implementations, a host may route messaging content communicated between computing platforms 118 in accordance with the communication sessions. The host may include, for example, server 102 and/or other host.

Computing platforms 118 may include one or more of a cellular telephone, a smartphone, a laptop, a tablet computer, a desktop computer, a television set-top box, smart TV, a gaming console, a client device, and/or other device suitable for the intended purpose(s) presented herein.

In some implementations, execution of a messaging application may be facilitated by information exchange among the computing platforms 118, server 102, and/or other information source. By way of non-limiting example, information defining the messaging application and/or operations of the messaging application may be provided to the computing platforms 118 based on information determined at server 102. For example, the server 102 may serve information describing functions, features, views of an interface of the messaging application, and/or other information to the computing platforms 118 according to client/server architecture. The computing platforms 118 may present views of the interface at displays of the computing platforms 118 based on the served information and/or other information.

In some implementations, information defining the messaging application and/or operations of the messaging application may be provided to the computing platforms 118 based on information determined locally at the computing platforms 118. For example, the computing platforms 118 may store machine-readable instructions 123 which, when executed, determine information describing functions, features, views of an interface of the messaging application, and/or other information associated with the messaging application. The computing platforms 118 may be configured to assemble and/or present views of the interface in displays of the computing platforms 118 based on the locally determined information, and/or other information. In some implementations, the messaging application may operate on the computing platforms 118 based on a combination of information served to the computing platforms 118, information determined locally at the computing platforms 118, and/or other information.

It is noted that descriptions directed to “a” computing platform, a “first” computing platform, a “second” computing platform, and/or other computing platform are to be understood as being descriptions for any one of the one or more computing platforms 118 included in the system. For example, descriptions of configurations of computing platforms 118 may be directed to a single recitation of “the” or “a” computing platform for clarity. However this is for clarity and illustration purposes only, and it is to be understood that other computing platforms 118 may be similarly configured.

A computing platform 118 may include one or more physical processors 122 configured to execute machine-readable instructions 123. The machine-readable instructions 123 may be stored in electronic storage 132 of the computing platform 118, and/or other storage location. The electronic storage 132 may include, for example, non-transitory computer-readable storage media. The machine-readable instructions 123 may include one or more of a user component 124, a messaging component 125, an updating component 126, a gaming component 128, and/or other components. The machine-readable instructions 123 may be executable by the computing platform 118 to facilitate gameplay within a messaging feed of a messaging application.

In some implementations, one or more portions of the machine-readable instructions 123 may comprise information downloaded to the computing platform 118. By way of non-limiting example, the computing platform 118 may download at least part of the machine-readable instructions 123 from the server 102, an external resource 120, and/or other sources. For example, the machine-readable instructions 123 may be downloaded to the computing platform 118 as part of a third party messaging application (e.g., an “app”). The computing platform 118 may obtain the machine-readable instructions 123 in other ways.

In some implementations, the user component 124 may be configured to access and/or manage one or more user profiles and/or user information associated with users of computing platform 118. The one or more user profiles and/or user information may include information stored by computing platform 118, server 102, one or more other computing platforms 118, and/or other storage locations. The user profiles may include, for example, information identifying users (e.g., a username or handle, a number, an identifier, and/or other identifying information) within the messaging application and/or communication session, security login information (e.g., a login code or password), subscription information, virtual (or real) currency account information (e.g., related to currency held in credit for a user), virtual inventory information (e.g., virtual inventories of virtual items associated with the users that include one or more virtual items available for the users in a game played in a messaging feed), relationship information (e.g., information related to relationships between users in the messaging application), usage information (e.g., a login history indicating the frequency and/or number of times the user logs-in to the user accounts), demographic information associated with users, communication history, information stated by users, browsing history of users, a computing platform identification associated with a user, a phone number associated with a user, and/or other information related to users.

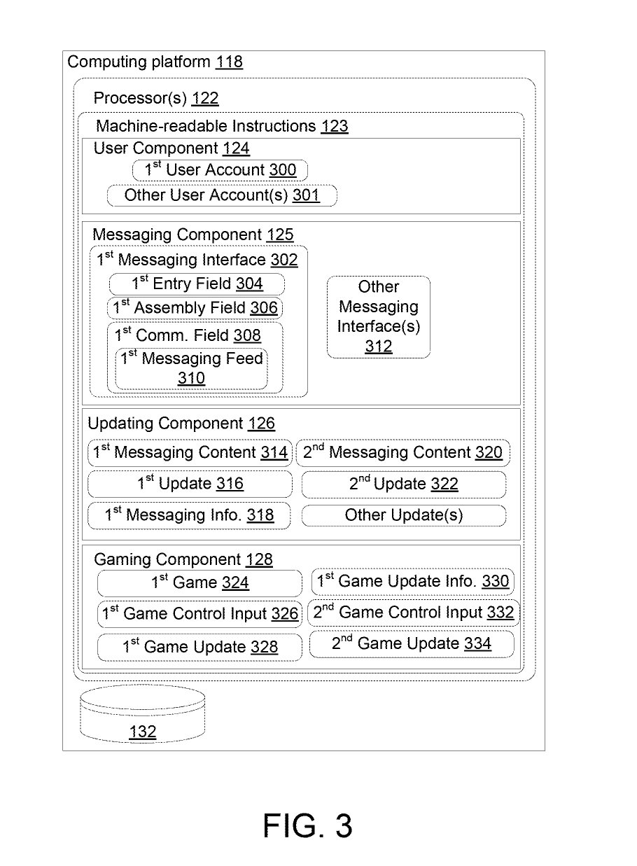

By way of non-limiting illustration in FIG. 3, the user component 124 may be configured to manage a first user account 300 associated with one or more users of the computing platform 118. The user component 124 may be configured to manage other user accounts 301 associated with one or more other users of the computing platform 118.

Returning to FIG. 1, in some implementations, the messaging component 125 may be configured to effectuate presentation of a messaging interface on a display of the computing platform 118. The messaging interface may include an entry field, an assembly field, a communication field, and/or other fields.

The entry field may be configured to display messaging content available for entry and/or selection by users. Messaging content may include one or more of text, an image, a video, audio, and/or other content. Text may include one or more of alphanumeric characters, symbols, and/or characters of one or more other writing systems. Images may include photographs, pictures, and/or graphical icons. Graphical icons may include one or more of an emoticon, an emoji, a sticker, a game icon, and/or other graphical icons. Graphical icons may be static and/or dynamic. For example, a dynamic icon may become briefly animated in a messaging feed. However, the dynamic nature of a graphical icon ends after the brief animation. The dynamic icon may become a static icon displayed in a messaging feed.

In some implementations, game icon-type graphical icons may correspond to messaging content that, when entered and/or selected by a user, effectuates presentation of a corresponding game within the messaging feed presented on the computing platform 118. In some implementations, game-icon type graphical icons may include messaging content that may be introduced into a game taking place in a messaging feed. By way of non-limiting example, a game presented on the messaging feed may include instances of game icons that may become a game entity within the game. By way of non-limiting example, entry and/or selection of a game icon may effectuate presentation of a game in a messaging feed, the game may include an instance of the game icon, and/or the game icon may comprise a game entity associated with and/or controlled by a user (e.g., the game icon may become the user's avatar).

In some implementations, an emoticon may comprise a set of text characters and/or symbols arranged to resemble an image (e.g., a face, a picture, and/or other image). In some implementations, an emoji may comprise an ideograph and/or other graphic symbol. In some implementations, emoticons may correspond to one or more emojis. By way of non-limiting example, entry and/or selection of an emoticon via the entry filed may result in a corresponding emoji being presented in a messaging feed.

In some implementations, the entry and/or selection of messaging content may update a messaging feed displayed in the communication field of the messaging interface. In some implementations, the entry and/or selection of messaging content may facilitate updates of messaging feeds displayed on one or more other computing platforms associated with a communication session, and/or may facilitate other operations.

An entry field may include various messaging content types available for entry and/or selection by users. In some implementations, the entry field may include one or more pages, tabs, windows, and/or portions that allow a user to choose among various available content types and/or entry and/or selection methods. In some implementations, the entry field may include an array of different messaging content types within a single display that may be available for entry and/or selection (e.g., a display including different emojis, game icons, text, and/or messaging content).

In some implementations, text-type messaging content may be entered and/or selected via a keyboard, voice input, and/or other user input method.

In some implementations, graphical icon-type messaging content may be entered and/or selected by providing input into the entry field corresponding to a displayed location of the graphical icons. By way of non-limiting example, an entry field may display an array, grid, and/or other display of various graphical icons. A user may select a given graphic icon by one or more available input mechanisms. Input mechanisms may include, for example, physical interface elements (e.g., depressible buttons, keys, and/or other elements), a touch-sensitive display, an input device included in or coupled with the computing platform 118 (e.g., a mouse, a joystick, keyboard, and/or other device), gesture recognition input, voice input, and/or other input mechanism. By way of non-limiting example, a user may hover a cursor over a display of a graphical icon and select the icon using an input mechanism (e.g., clicking a mouse). By way of non-limiting example, a user may finger-tap a portion of a touch-sensitive display that shows a desired graphical icon.

In some implementations, a user may select a graphical icon using text-based entry. By way of non-limiting example, a user may input a textual portrayal of a graphic icon (e.g., emoticon) into the assembly field using symbols present on a keyboard. When the user submits the input (e.g., selects a “send” option), the communication field may be updated to include a corresponding graphical icon.

In some implementations, an assembly field may reflect messaging content entered and/or selected from the entry field. The assembly field may show an assembly of the entered and/or selected messaging content based on sequential entry and/or selection of the messaging content by a user. In some implementations, the assembly field may be configured to perform one or more functions of the messaging application including automatic spelling corrections (e.g., “autocorrect”), word predictions, and/or other features and/or functions. In some implementations, the assembly field may include one or more pages, tabs, windows, selectable interface elements, and/or portions that allow a user to choose among various available content types and/or entry and/or selection mechanisms available within the entry field.

In some implementations, the communication field may display a messaging feed that reflects a communication session between the computing platform 118 and one or more other computing platforms. The messaging feed may include messaging content previously entered and/or selected by a user of the computing platform 118 and/or other users of other computing platforms. In some implementations, the messaging feed may be updated based on entry and/or selection of messaging content by the user via the entry field and/or based on entry and/or selection of a “send” interface element included in the assembly field. In some implementations, user entry and/or selection of messaging content from the entry field may automatically update the messaging feed based on the entries and/or selections. In some implementations, entry and/or selection of messaging content from the entry field may first be reflected by instances of the messaging content appearing in an assembly area of the assembly field (e.g., as a preview). The messaging feed may be updated to include messaging content based on entry and/or selection of an interface element included in the assembly field (e.g., a selectable element labeled “send,” and/or other term).

Messaging content entered and/or selected by the various users participating in the communication session may be distinguished by separating messaging content within the messaging feed and/or otherwise distinctively associating messaging content with the appropriate user that submitted the content. By way of non-limiting example, users may be represented by identifying text, avatars, and/or graphical user icons shown in the messaging feed. Messaging content entered and/or selected by individual ones of the users may be displayed in separate chat bubbles that are connected to and/or otherwise distinctively associated with user representations in the messaging feed.

In some implementations, incoming messaging content may cause one or more previously entered and/or selected content displayed in the messaging feed to scroll to a new position within the messaging feed to make room for the new incoming content. In some implementations, games presented in messaging feeds may be displayed the same as or similar to other messaging content (e.g., text content) presented in a feed (e.g., games may also scroll within the messaging feed based on new content being introduced into the feed). Messaging feeds may present messaging content in other ways.

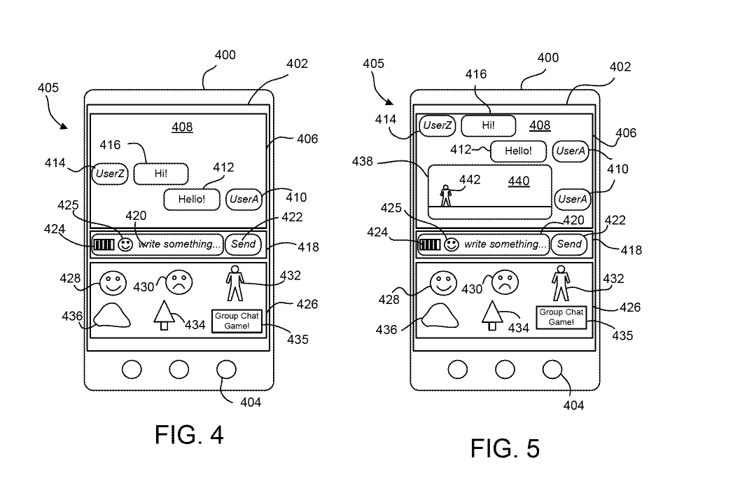

By way of non-limiting illustration in FIG. 4, an exemplary implementation of a first computing platform 400 is shown. The first computing platform 400 may comprise, for example, a handheld smartphone and/or other computing platform. The first computing platform 400 may include one or more physical processors (now shown in FIG. 4) configured to execute machine-readable instructions to perform a method for facilitating gameplay within a messaging feed of a messaging application.

The first computing platform 400 may include a display 402. The display 402 may be a touch-sensitive screen and/or other display type. The first computing platform 400 may include one or more physical interface elements 404 (e.g., depressible buttons). One or more of the display 402, physical interface elements 404, and/or other components of the first computing platform 400 may facilitate user input. In some implementations, other input mechanisms may be included in or coupled to the first computing platform 400. By way of non-limiting example, the first computing platform 400 may include a track ball, a microphone (e.g., to facilitate voice input), a camera (e.g., to facilitate gesture input), and/or other devices. The first computing platform 400 may be configured to communicatively couple with a keyboard, a joystick, a mouse, and/or other input mechanism. The first computing platform 400 may include other components through which a user may provide input.

A messaging interface 405 of a messaging application may be presented on the display 402. The messaging interface 405 may include a first communication field 406, a first assembly field 418, a first entry field 426, and/or other fields. The first entry field 426 may be configured to display messaging content available for entry and/or selection by a user of the first computing platform 400. The current depiction of the first entry field 426 shows an array of graphical icons available for entry and/or selection by a user. However, other implementations of the first entry field 426 may include other messaging content types. By way of non-limiting example, interface elements 424 and/or 425 of the first assembly field 418 may facilitate switching between implementations of the first entry field 426. Different implementations of the first entry field 426 may include displaying a keyboard-type entry mechanism (e.g., via selection of element 424), a graphical icon array (e.g., via selection of element 425), and/or other implementations.

In some implementations, the graphical icons available for entry and/or selection by a user may be determined based on subscription information associated with a user account (e.g., based on user component 124). By way of non-limiting example, users may purchase and/or acquire one or more graphical icons to make the one or more graphical icons available to the user. By way of non-limiting example, users may purchase graphical icons via a virtual shop (not shown). Users may make purchases with real (or virtual) currency. In some implementations, a standard and/or base set of graphical icons may be provided to one or more users who participate in the messaging application (e.g., download the messaging app).

Graphical icons shown in the first entry field 426 may include one or more of a first icon 428, a second icon 430, a third icon 432, a fourth icon 434, a fifth icon 436, a sixth icon 435, and/or more or fewer icons. One or more of the graphical icons may include static icons, dynamic icons, game icons, and/or other types of graphical icons. By way of non-limiting example, the first icon 428 and second icon 430 may comprise static and/or dynamic icons (e.g., smiley faces); and the third icon 432, fourth icon 434, fifth icon 436, and sixth icon 435 may comprise game icons. Briefly, sixth icon 435 may comprise a group gameplay game icon, described in more detail herein.

First assembly field 418 may be configured to reflect entered and/or selected messaging content by a user via the first entry field 426. The first assembly field 418 may display an assembly of the entered and/or selected messaging content based on sequential entry and/or selection of the messaging content by a user. By way of non-limiting example, the user may type in a character string (e.g., one or more symbols, words, sentences, and/or phrases) using a keyboard-type entry mechanism in the first entry field 426 (not shown in FIG. 4). The first assembly field 418 may be configured to display the string within an assembly area 420 as individual characters are entered and/or selected. In some implementations, the user may provide input to select a graphical icon. The entry and/or selection may be represented by an instance of the graphical icon appearing in the assembly area 420. In some implementations, the user may finalize their entry and/or selection by submitting the content for display in the first messaging feed 408. By way of non-limiting example, a user may enter and/or selection a “send” interface element 422 included in the first assembly field 418 configured to facilitate displaying content from the assembly area 420 into the first messaging feed 408.

In some implementations, the first communication field 406 may be configured to display a first messaging feed 408. The first messaging feed 408 may reflect a communication session between the first computing platform 400 and one or more other computing platforms. The messaging feed 408 may include messaging content. The messaging content may include content previously entered and/or selected by a first user of the first computing platform 400 through one or both of the first entry field 426 or the first assembly field 418. In some implementations, the first messaging feed 408 may include a first user icon 410 and/or other identification that may represent the first user (e.g., “UserA”) of the first computing platform 400. The first messaging feed 408 may include messaging content 412 entered and/or selected by the first user of the first computing platform 400.

The first messaging feed 408 may include messaging content previously entered and/or selected by one or more other users through the one or more other computing platforms. By way of non-limiting example, the first messaging feed 408 may include a second user icon 414 and/or other identification that may represent a second user (e.g., “UserZ”) of a second computing platform (not shown in FIG. 4). The first messaging feed 408 may include other messaging content 416 entered and/or selected by other users through one or more other computing platforms. In some implementations, the respective messaging content entered by the users may be represented by separate chat bubbles within the first messaging feed 408, and/or may be distinguished in other ways.

By way of non-limiting illustration in FIG. 3, the messaging component 125 may be configured to effectuate presentation of a first messaging interface 302. The first messaging interface 302 may include a first entry field 304, a first assembly field 306, a first communication field 308, and/or other fields. The first communication field 308 may display a first messaging feed 310 reflecting a communication session between the computing platform 118 and one or more other computing platforms (not shown in FIG. 3).

Returning to FIG. 1, the updating component 126 may be configured to receive entry and/or selection of messaging content from a user of the computing platform 118. By way of non-limiting example, the updating component 126 may be configured to receive entry and/or selection of messaging content via one or more input mechanisms included in or coupled to the computing platform 118.

In some implementations, the updating component 126 may be configured to update a messaging feed of a communication field presented on the computing platform 118. The messaging feed may be updated to present instances of the entered and/or selected messaging content. By way of non-limiting example, a user may select a graphical icon from an entry field of the messaging interface. The messaging feed may be updated to include an instance of the graphical icon.

In some implementations, the updating component 126 may be configured to update a messaging feed presented on the computing platform 118 to include messaging content entered and/or selected by one or more other users of one or more other computing platforms that share a communication session with the computing platform 118. By way of non-limiting example, the updating component 126 may be configured to receive information describing messaging content entered and/or selected by the one or more other users. Based on the received information, the updating component 126 may be configured to receive information describing messaging content over network 116. The updating component 126 may be configured to determine the messaging content entered and/or selected by the other users and present instances of the messaging content in the messaging feed. In some implementations, the received information may include information identifying the user and/or computing platform associated with the user who entered and/or selected the messaging content. The updating component 126 may be configured to update a messaging feed such that incoming messaging content may be presented in accordance with an appropriate sending user.

In some implementations, the updating component 126 may be configured to communicate information describing the messaging content entered and/or selected by a user if the computing platform 118 to facilitate updating messaging feeds of other computing platforms sharing a communication session. The communicated information may include information identifying one or both of the sending computing platform and/or user associated with the entry and/or selection.

In some implementations, the updating component 126 may send and/or receive information over network 116. In some implementations, the information sent and/or received by the updating component 126 may include information routed to and/or from the server 102, external resource 120, and/or other entities. In some implementations, information sent and/or received by the updating component 126 may include information routed to and/or from a cell network and/or corresponding entities, a local area network and/or corresponding entities, and/or other networks and/or entities.

By way of non-limiting illustration in FIG. 3, the updating component 126 may be configured to receive entry and/or selection of first messaging content 314 from a user of the computing platform 118. The updating component 126 may be configured to effectuate a first update 316 of the first messaging feed 310. The first update 316 may correspond to presenting a first instance of the first messaging content 314 in the first messaging feed 310. In some implementations, the updating component 126 may be configured to communicate first messaging information 318 describing the first messaging content 314 to facilitate updating other messaging feeds of other computing platforms sharing a communication session with the computing platform 118.

In some implementations, the updating component 126 may be configured to obtain information describing messaging content entered and/or selected by one or more other users through one or more other computing platforms. By way of non-limiting example, the updating component 126 may be configured to receive information describing second messaging content 320 entered and/or selected by a second user (not shown in FIG. 3) via a second computing platform (not shown in FIG. 3). The computing platform 118 and/or second computing platform may be associated with a communication session. The updating component 126 may be configured to effectuate a second update 322 of the first messaging feed 310 to present an instance of the second messaging content 320 based on the obtained information. In some implementations, the second update 322 may comprise scrolling the presented instance of the first messaging content 314 from a first position on the first messaging feed 310 to a different position. Scrolling may comprise moving messaging content from a first position in the messaging feed to a second position in the messaging feed. Messaging content may be presented in the messaging feeds in other ways.

Returning to FIG. 1, the gaming component 128 may be configured to effectuate presentation of games within a messaging feed responsive to entered and/or selected messaging content including a game icon. The gaming component 128 may be configured to execute an instance of the game to facilitate user participation in the game. In some implementations, the instance of the game may be executed based on information that may be local to the computing platform 118. The instance of the game may be executed by the gaming component 128 to determine a state of the game. The state determined and presented by the computing platform 118 may correspond to a location in the game. The view described by the state may correspond, for example, to a location from which the view is taken, the location the view depicts, and/or other locations, a zoom ratio, a dimensionality of objects, a point-of-view, and/or view parameters of the view. One or more of the view parameters may be selectable by the users. Other implementations where the game may be presented based on information received from server 102 are presented in more detail herein.

An instance of the game may comprise a simulated space that is accessible by the users via the computing platform 118 that presents the views of the game to the users. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space and/or surface features of a surface or objects that are “native” to the space. In some instances, the topography may describe a surface (e.g., a ground surface) that runs through at least a substantial portion of the space (e.g., comprising at least part of a virtual terrain). In some instances, the topography may describe a volume with one or more bodies positioned therein (e.g., a simulation of gravity-deprived space with one or more celestial bodies positioned therein). An instance executed by the computer components may be synchronous, asynchronous, and/or semi-synchronous.

In some implementations, the different computing platforms 118 may execute different instances of a game for implementation on the respective computing platforms. In some implementations, the different instances may be related. In some implementations, the different instances may be unrelated. For example, the different instances executed by different computing platforms 118 may have started from a same or similar state. The users of the respective computing platforms 118 may modify and/or interact with the game differently within the respective executed instances. In some implementations, the gaming component 128 of different computing platforms may express the game differently.

The above description of the manner in which the state of the game is determined by gaming component 128 is not intended to be limiting. The gaming component 128 may be configured to express the game in a more limited, or rich, manner. For example, views determined for the game representing the state of the instance of the game may be selected from a limited set of graphics depicting an event in a given place within the game. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within an instance of the game executed by gaming component 128, users may control game entities, simulated physical phenomena (e.g., wind, rain, earthquakes, and/or other phenomena), and/or other elements within the game to interact with the game and/or other users. The game entities may include virtual characters, such as avatars, game icons, and/or other entities. A given game entity, game icon, and/or group of game entities may be controlled by a user with which it is associated. The user-controlled element(s) may move through and interact with the game (e.g., non-user characters in the game and/or other objects in the game). The users may have an “inventory” of virtual items, game entities, and/or currency that the user can use within the game.

Users may participate in an instance of the game by controlling one or more of the available user-controlled game entities in the game. Control may be exercised through game control inputs such as entry, selection, and/or commands input by the users through a messaging interface presented at the computing platform 118. Users may interact through communications exchanged within the messaging feed while the game continues to take place in the messaging feed. Such communications may include one or more of textual chat, graphical icons, voice communications, other games, and/or other communications.

An instance of a game that takes place in a messaging feed may be persistent. That is, the game may continue on whether or not individual users are currently logged in and/or participating in the game. A player who logs out of the messaging application and then logs back in some time later may find the game has been changed through the interactions of other users with the game during the time the user was logged out. These changes may include changes to the simulated physical space, changes in the user's inventory, changes in other user's inventories, changes experienced by non-player characters, changes to the virtual items available for use in the game, and/or other changes.

In some implementations, game control input may correspond to one or more of controlling instances of game entities presented in the game, introducing game entities into the game, and/or other game control input.

In some implementations, game control input may be facilitated by entry and/or selection of a game icon presented within a messaging feed, entry and/or selection of a game icon presented in an entry field, providing input via one or more input mechanisms included in or coupled to the computing platform 118, and/or other input.

By way of non-limiting example, game control input through entry and/or selection of a game icon presented within a messaging feed may comprise touching, tapping, swiping, and/or providing other input at a location of a touch-sensitive screen of the computing platform 118. By way of non-limiting example, a game icon may be presented in a messaging feed as a game entity (e.g., avatar) representing a user. A user may control the game entity within the game by touching, tapping, swiping, and/or providing other input at a location of a touch-sensitive screen where the game entity may be presented (e.g., a location in the communication field and/or other field). Game control inputs may be provided in other ways.

By way of non-limiting example, game control input through entry and/or selection of a game icon presented within an entry field may comprise touching, tapping, swiping, and/or providing other input at a location of a touch-sensitive screen of the computing platform. By way of non-limiting example, a game icon may be presented in the entry field. A user participating in a game may wish to introduce the game icon into the game. The user may provide entry and/or selection of the game icon in the entry field such that an instance of the entered and/or selected game icon may be then subsequently be presented in the game shown in the messaging feed. Game control inputs may be provided in other ways.

In some implementations, the gaming component 128 may be configured to update a game in a messaging feed of the computing platform 118 based on game control inputs provided by other users viewing other instances of the game on other computing platforms. By way of non-limiting example, by virtue of the computing platform 118 and one or more other computing platforms sharing a communication session, game control inputs entered and/or selected by other users via other computing platforms may be reflected in the instance of the game presented in the messaging feed of the computing platform 118.

In some implementations, the gaming component 128 may be configured to communicate game update information to update a game in a messaging feed of one or more other computing platforms based on game control inputs provided by a user of the computing platform 118. By way of non-limiting example, by virtue of the computing platform 118 and one or more other computing platforms sharing a communication session, game update information describing game control inputs entered and/or selected by a user of the computing platform 118 may be communicated to other computing platforms of other users sharing the communication session.

In some implementations, the gaming component 128 may be configured to effectuate presentation of a game based on information received from server 102 and/or other source. By way of non-limiting example, the server 102 may include a gaming component 110 configured to execute an instance of the game and implement the instance of the game to determine state of the game. The state may be communicated (e.g., via streaming visual data, object/position data, and/or other state information) from server 102 to the computing platforms 118 (e.g., gaming component 128) for presentation to users in messaging feeds. In some implementations, games in messaging feeds may be updated based on game control inputs entered and/or selected at the computing platforms 118 being routed through the server 102 (e.g., the gaming component 110) and to the appropriate computing platforms 118 that share a communication session.

By way of non-limiting illustration in FIG. 3, by virtue of the first messaging content 314 comprising a game icon, the gaming component 128 may be configured to execute an instance of a first game 324 on the computing platform 118. The gaming component 128 may be configured to effectuate presentation of views of the instance of the first game 324 in the first messaging feed 310. In some implementations, the first game 324 may include an instance of the game icon presented in the first messaging feed 310. In some implementations, the game icon may comprise a game entity associated and/or controlled by the user who entered and/or selected the first messaging content 314.

In some implementations, the gaming component 128 may be configured to receive first game control input 326 entered and/or selected by a user of the computing platform 118. The gaming component 128 may be configured to effectuate a first game update 328 based on the first game control input 326. By way of non-limiting example, the first game control input 326 may correspond to moving the game icon within the game. The first game update 328 may correspond to effectuating the corresponding moves in the game presented in the first messaging feed 310.

In some implementations, the gaming component 128 may be configured to communicate first game update information 330 to one or more other computing platforms sharing a communication session with the computing platform 118. The first game update information 330 may correspond to the first game control inputs 326. The first game update information 330 may facilitate effectuating the first game control input 326 in other messaging feeds of other computing platforms presenting other instances of the first game 324. In some implementations, the first game update information 330 may be communicated to the one or more other computing platforms based on information routing through server 102 (FIG. 1).

In some implementations, the gaming component 128 may be configured to receive information describing second game control input 332. The second game control input 332 may correspond to control inputs entered and/or selected by other users of other computing platforms sharing a communication session with computing platform 118. The gaming component 128 may be configured to effectuate a second game update 334 within the first messaging feed 310 based on the information describing the second game control input 334. By way of non-limiting example, the second game control input 334 may correspond to introducing a game icon into the first game 324. The introduced game icon and the game icon corresponding to the first messaging content 314 may interact within the first game 324.

Returning to FIG. 1, server 102 may include one or more physical processors 104 configured to execute machine-readable instructions 105. The machine-readable instructions 105 may be stored in electronic storage 114, and/or other storage location. The machine-readable instructions 105 may include one or more of a user component 106, a receiving component 107, an updating component 108, a gaming component 110, and/or other components. The machine-readable instructions 105 may be executable by processor(s) 104 to facilitate gameplay within messaging feeds of messaging applications on computing platforms 118 associated with users.

In some implementations, the user component 106 may be configured to access and/or manage one or more user profiles and/or user information associated with users of the computing platforms 118. The one or more user profiles and/or user information may include information stored by one or more computing platforms 118, server 102, and/or other storage locations. By way of non-limiting example, the user component 106 may access and/or manage information stored by the user components 124 of the computing platforms 118. In some implementations, the same or similar information may persist between the user components 124 of computing platforms 118 and user component 106 of server 102.

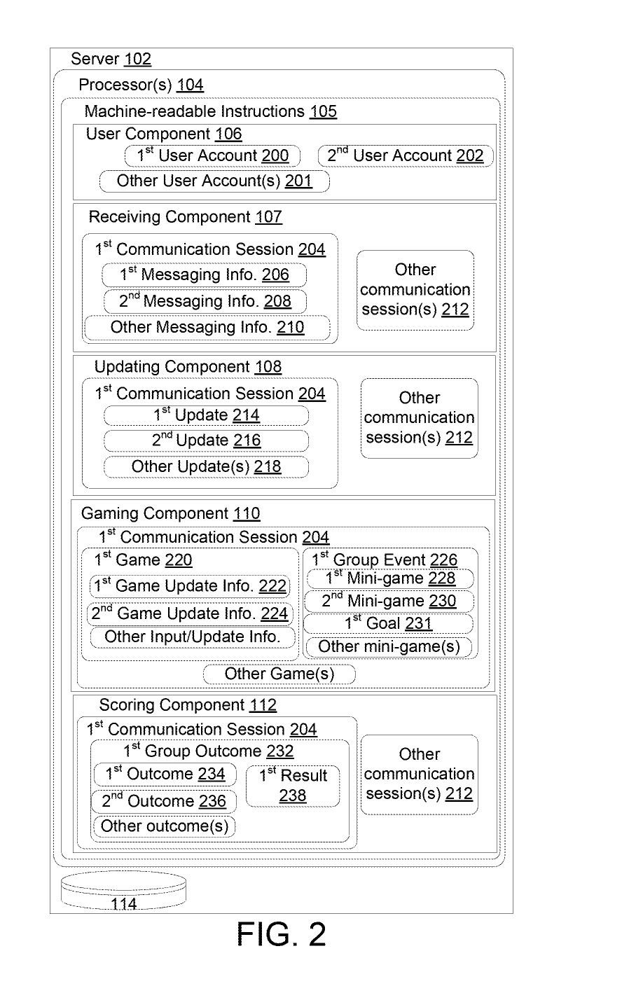

By way of non-limiting illustration in FIG. 2, the user component 106 may be configured to manage a first user account 200 associated with one or more users of a first computing platform (not shown in FIG. 2). The user component 106 may be configured to manage a second user account 202 associated with one or more users of a second computing platform (not shown in FIG. 2). The user component 106 may be configured to manage other user account(s) 201 associated with one or more other users of one or more other computing platforms.

Returning to FIG. 1, the receiving component 107 may be configured to receive messaging information describing messaging content entered and/or selected by users through computing platforms 118 associated with communication sessions. The messaging content may be entered and/or selected by users via messaging interfaces presented at the computing platforms 118 (see, e.g., messaging component 125 described herein).

In some implementations, messaging information describing messaging content may include information identifying a user and/or computing platform sending the messaging content, one or more users and/or computing platforms intended as recipients of the messaging content in accordance with a communication session, and/or other information. In some implementations, information describing messaging content may include information used to look up the messaging content from a database of messaging content. By way of non-limiting example, messaging information describing messaging content may include keys, identifiers, pointers, network addresses, and/or other information used by the receiving component 107 to look up the corresponding messaging content. By way of non-limiting illustration, users may enter and/or select messaging content at a computing platform. The computing platform may communicate, to the server 102, identifiers that point to what the corresponding messaging content is. The identifiers and/or other messaging information may be received by the receiving component 107.

In some implementations, messaging information describing messaging content may include the messaging content and/or a representation (e.g., a copy) of the messaging content. By way of non-limiting example, messaging information describing messaging content may include messaging content and/or a copy of messaging content entered and/or selected by a user a computing platform. By way of non-limiting illustration, users may enter and/or select messaging content at a computing platform. The computing platform may communicate, to the server 102, a copy of the messaging content. The copy may be received by the receiving component 107.

By way of non-limiting illustration in FIG. 2, the receiving component 107 may be configured to receive first messaging information 206 describing first messaging content entered and/or selected by a first user through a first computing platform. The first computing platform may be associated with a first communication session 204. The receiving component 107 may be configured to receive second messaging information 208 describing second messaging content entered and/or selected by a second user through a second computing platform. The second computing platform may be associated with the first communication session 204. The receiving component 107 may be configured to receive other messaging information 210 describing messaging content entered and/or selected by the first user, second user, and/or other users through one or more computing platforms. The receiving component 107 may be configured to receive information describing messaging content entered and/or selected by users through computing platforms associated with other communication sessions 212.

Returning to FIG. 1, the updating component 108 may be configured to effectuate updates of messaging feeds of messaging interfaces presented on the computing platforms based on the received messaging information. The updating component 108 may be configured such that updates may correspond to presenting instances of messaging content in the messaging feeds. In some implementations, effectuating updates may comprise communicating, to recipient computing platforms within a communication session, messaging information describing messaging content to be presented in a messaging feed of a messaging interface presented at the recipient computing platforms 118. In some implementations, the communicated messaging information may comprise the messaging information received by the receiving component 107. By way of non-limiting example, the server 102 may relay messaging content and/or information describing messaging content between computing platform within a communication session.

By way of non-limiting illustration in FIG. 2, the updating component 108 may be configured to effectuate a first update 214 of a first messaging feed presented on a first computing platform based on the received second messaging information 208. The first update 214 may correspond to presenting an instance of the second messaging content in the first messaging feed. The first update 214 may include communicating messaging information describing the second messaging content to the first computing platform.

In some implementations, the updating component 108 may be configured to effectuate a second update 216 of a second messaging feed presented on a second computing platform based on the received first messaging information 206. The second update 216 may correspond to presenting an instance of the first messaging content on the second messaging feed. The second update 216 may include communicating messaging information describing the first messaging content to the second computing platform. The updating component 108 may be configured to effectuate other updates 218 of other messaging feeds of other computing platforms associated with the first communication session 204.

Returning to FIG. 1, the gaming component 110 may be configured to execute instances of games and implement the instances to determine states of the games. The states may be communicated (e.g., via streaming visual data, object/position data, and/or other state information) from server 102 to the computing platforms 118 to effectuate presentation of the games in messaging feeds. In some implementations, the gaming component 110 may be configured to execute instances of games and/or effectuate presentation of games in messaging feeds by virtue of messaging information received by the receiving component 107 describing messaging content including game icons entered and/or selection by users. In some implementations, the games may include instances of the entered and/or selected game icons.

In some implementations, the gaming component 110 may be configured to receive game update information describing game control inputs entered and/or selected by users through the computing platforms 118. The gaming component 110 may be configured to determine one or more game control inputs and/or other information from the received game update information. The gaming component 110 may be configured to facilitate updates of messaging feeds based on the received game updated information. By way of non-limiting example, the gaming component 110 may be configured to effectuate the game control inputs in the games presented in the messaging feeds to update the messaging feeds. The gaming component 110 may be configured to determine updated states of the games based on the game control inputs. By way of non-limiting example, an updated state may be communicated to appropriate computing platforms such that views of a game presented on the computing platforms may reflect the changes in the state in accordance with the game control inputs.

By way of non-limiting illustration in FIG. 2, the gaming component 110 may be configured to, by virtue of the first messaging content comprising a first game icon, execute instances of a first game 220. The gaming component 110 may be configured to effectuate presentation of the first game 220 within the first messaging feed of the first computing platform by implementing a first instance of the first game 220 to determine a first state of the first game. The gaming component 110 may be configured to effectuate presentation of the first game 220 within the second messaging feed of the second computing platform by implementing a second instance of the first game 220 to determine a second state of the first game. The gaming component 110 may be configured to effectuate presentation of the first game 220 on other messaging feeds of other computing platforms associated with the first communication session 204.

In some implementations, the presentation of the first game 220 in the first and second messaging feeds may facilitate participation by the first user and/or second user in the first game. In some implementations, the first state of the first game 220 may include a first instance of the first game icon. In some implementations, the second state of the first game 220 may include a second instance of the first game icon. The first user may participate in the first game by controlling the instances of the first game icon.

In some implementations, the gaming component 110 may be configured to receive first game update information 222. The first game update information 222 may describe first game control inputs entered and/or selected by a first user through a first computing platform. The gaming component 110 may be configured to effectuate the first game control inputs by updating the states of the first game 220. The updated states of the first game may be communicated to the first computing platform, a second computing platform, and/or other computing platforms associated with the first communication session 204.

In some implementations, the gaming component 110 may be configured to receive second game update information 224. The second game update information 224 may describe second game control inputs entered and/or selected by a second user through a second computing platform. The second control inputs may correspond to entry and/or selection of a second game icon. The gaming component 110 may be configured to effectuate the second game control inputs by updating states of the first game 220 to include instances of the second game icon. By way of non-limiting example, the first state of the first game 220 may be updated to include a first instance of the second game icon. The second state of the first game 220 may be updated to include a second instance of the second game icon.

In some implementations, the gaming component 110 may be configured to effectuate presentation of mini-games within messaging feeds of computing platforms in accordance with group gameplay events between users of the computing platforms. In some implementations, messaging content may include group gameplay game icons. Entry and/or selection of a group gameplay game icon by a user through a computing platform may effectuate presentation of a request to initiate a group gameplay event between the user and other users of a shared communication session. The request may be presented within messaging feeds displayed in computing platforms associated with the users. Users may provide entry and/or selection of an answer to the request within the messaging feeds. Responsive to one or more users accepting the request, a group gameplay event between the accepting users may be effectuated. The users that have accepted a request may be referred to as a “group.”

In some implementations, group gameplay events may correspond to users of a group achieving a group gameplay outcome. The group outcome may be based on outcomes of individual participation by the users within individual mini-games associated with the group gameplay event. The users may individually participate in a respective mini-game. The users may achieve outcomes within the respective mini-games. The group outcome may correspond to a combination of the individual outcomes from user participation in the mini-games.

In some implementations, outcomes may be numerical (e.g., points, amount, score, rank, ratings, place, grades, or any other type of numerical value), descriptive (e.g., “good,” “great,” “bad,” “worst,” and/or other description), progressive (e.g., high, medium, low, and/or other description), pictorial (e.g., a first place trophy, a second place trophy, a third place trophy, and/or other imagery), and/or any other type of numerical outcome. For example, outcomes may correspond to a point achievement associated with user participation in a mini-game. A group outcome may include a combined value of points obtained by individual ones of the users within the respective mini-games. Outcomes may be expressed in other ways.

In some implementations, group gameplay events may be associated with a goal and/or objective. The goal and/or objective may correspond to a predetermined outcome. By way of non-limiting example, a goal and/or objective for a group gameplay event may be a predetermined numerical outcome (e.g., “X” amount of points), and/or other outcome.

In some implementations, group gameplay events may be timed. In some implementations, timed group gameplay events may start based on one or more triggers. A trigger may include one or more of a predetermined number of users accepting a group gameplay event request, at least one of the users participating in the group gameplay event starting participation in a corresponding mini-game, and/or other triggers.

In some implementations, the length of timed group gameplay events may be determined in a variety of ways. In some implementations, group gameplay events may be associated with a predetermined length of time. By way of non-limiting example, group gameplay events may be 30 seconds, 1 minute, 2 minutes, 3 minutes, and/or other length of time. In some implementations, the length of timed group gameplay events may be determined based on one or more factors. In some implementations, a factor may include one or more of the number of users participating in a group gameplay event, the type of mini-games associated with the group gameplay event, permissions of one or more of the users participating in the group gameplay event, and/or other factors. In some implementations, the greater the number of players, the more time the group may be given to complete their corresponding group gameplay event. By way of non-limiting example, a group comprising two users may be given less time than group comprising six users.

In some implementations, mini-games associated with group gameplay events may be individually timed. By way of non-limiting example, individual ones of the users may have a time period in which they can participate in the mini-game. In some implementations, the users may be required to complete their participation in the mini-games within the time period of the group gameplay events. By way of non-limiting example, a group gameplay event may be limited by a first time period, while individual mini-games played by users in a group may be limited by a second time period that takes place within the first time period. The second time period may comprise a fraction of the first time period. By way of non-limiting example, a group gameplay event may be one minute long. Minigames associated with the group gameplay event may be limited to 15 seconds of game play. Once the timer for the group gameplay event beings, users may have to start and/or complete their respective minigames before the end of the group gameplay event.

In some implementations, individual ones of the mini-games may be multiplayer games. By way of non-limiting example, two or more users in a group may participate in the same mini-game while two or more other users in the group may participate in another mini-game. In some implementations, all users of a group may participate in a single mini-game that may comprise the entirety of the group gameplay event.

The gaming component 110 may be configured to execute instances of mini-games and implement the instances to facilitate participation by individual users in individual ones of the mini-games. The mini-games may be executed to determined state of the mini-games. The state of individual ones of the mini-games may be communicated to appropriate computing platforms according to client/server architecture.

By way of non-limiting illustration in FIG. 2, the receiving component 107 may be configured to receive entry and/or selection of messaging content, including a first group gameplay icon by a first user via a first computing platform. The first user may be associated with a first computing platform. A second user may be associated with a second computing platform. The first and second computing platforms may be associated by the first communication session 204. The updating component 108 may be configured to effectuate an update of the messaging feeds of the first computing platform and second computing platform to include a first request (not shown in FIG. 2) corresponding to the first group gameplay icon. The first request may include options for user entry and/or selection of an acceptance of the request, rejection of the request, and/or the user may ignore the request presented within the messaging feeds. Based on one or more other users accepting the request, a group gameplay event between the first user and one or more other users may be initiated. If no users accept the first request, the group gameplay event may not proceed.

The gaming component 110 may be configured to effectuate a first group event 226 between the first user and the second user (e.g., the second user may have accepted a first request). The first group event 226 may be associated with a first goal 231. The first goal 231 may comprise, for example, a first predetermined outcome.

In some implementations, effectuating the first group event 226 may include executing a first mini-game 228, a second mini-game 230, and/or other mini-games. A determined state of the first mini-game 228 may be communicated to a first computing platform associated with the first user. The first mini-game 228 may be presented on a first messaging feed of the first computing platform. A determined state of the second mini-game 230 may be communicated to a second computing platform associated with the second user. The second mini-game 230 may be presented on a second messaging feed of the second computing platform. In some implementations, the first mini-game 228 and second mini-game 230 may be separate and distinct from each other. For example, the second user may be unable to participate in the first mini-game 228 and/or the first user may be unable to participate in the second mini-game 230.

Returning to FIG. 1, the scoring component 112 may be configured to determine outcomes for individual ones of the mini-games played by users participating in group gameplay events. The scoring component 112 may be configured to determine outcomes of group gameplay events between users. The group gameplay event outcomes may be determined based on outcomes of individual ones of the mini-game played by individual users in a group. By way of non-limiting example, the outcomes of group gameplay events may be based on a combination of the outcomes of one or more mini-games associated with a given group gameplay event.

The scoring component 112 may be configured to determine results of the group gameplay events. Results may be determined based on a comparison between the determined outcomes of the group gameplay events and corresponding goals and/or objectives for the group gameplay events. In some implementations, results may be expressed numerically (e.g., percentage of points achieved to the points required to win, a total amount of points achieved, and/or any other type of numerical expression), descriptive (e.g., “win,” “lose,” “tie,” “almost,” and/or other description), progressive (e.g., good, better, best, and/or other progressive description), pictorial (e.g., a first place trophy, a second place trophy, a third place trophy, a smiley face, a frown face, and/or other imagery), and/or any other type of expression. By way of non-limiting example, a “win” and/or other result may be determined based on the determined outcome meeting and/or exceeding a goal and/or objective. By way of non-limiting example, a “lose” and/or other result may be determined based on the determined outcome failing to meet or exceed a goal and/or objective.

In some implementations, the scoring component 112 may be configured to effectuate presentation of one or more of the mini-game outcomes, the group gameplay event outcomes, and/or determined results on one or more computing platforms of users participating in group gameplay events. In some implementations, one or more of the mini-game outcomes, the group gameplay event outcomes, and/or the determined results may be presented in messaging feeds presented on the computing platforms 118.

In some implementations, individual ones of the mini-game outcomes may be presented in messaging feeds of the users associated with a given group based on individual ones of the users completing participation in a corresponding mini-game. By way of non-limiting example, a first user may finish participation in a first mini-game and achieve a first outcome. The first outcome may be presented in messaging feeds of computing platforms associated with users in the group. In some implementations, users that may have not participated in group gameplay events, but who may share a communication session with other users that have, may still receive the mini-game outcomes, the group gameplay event outcomes, and/or determined results associated with the other users in their messaging feeds.

By way of non-limiting illustration in FIG. 2, the scoring component 112 may be configured to determine a first group outcome 232 associated with the first group event 226. The first group outcome 232 may be determined based on a first outcome 234 of the first mini-game 228, a second outcome 236 of the second mini-game 230, and/or other outcomes of other mini-games associated with the first group gameplay event 226. By way of non-limiting example, the first outcome 234 may comprise a first numerical score achieved by the a first user, the second outcome 236 may comprise a second numerical score achieved by a second user, and/or the first group outcome 232 may be a combination of the first numerical score and the second numerical score.

In some implementations, scoring component 112 may be configured to determine a first result 238 of the first group event 226. In some implementations, the first result 238 may be determined based on a comparison between the determined first group outcome 232 and the first goal 231. By way of non-limiting example, a “win” and/or other result may be determined based on the first group outcome 232 meeting or exceeding the first goal 231. By way of non-limiting example, a “lose” and/or other outcome may be determined based on the first group outcome 232 failing to meet or exceed the first goal 231.

In some implementations, the scoring component 112 may be configured to effectuate presentation of one or more of the first outcome 234, the second outcome 236, the first group outcome 232, and/or the first result 238 in one or more of a first messaging feed associated with the first user, a second messaging feed associated with the second user, and/or other messaging feeds associated with other users of the first communication session 204.

FIGS. 4 and 5 illustrate an exemplary first computing platform 400 presenting a messaging interface 405 of a messaging application. FIG. 5 illustrates the presentation of a first instance of a game 440 within the first messaging interface 408. The first instance of the game 440 may be presented responsive to entry and/or selection by a first user (e.g., “UserA”) of messaging content comprising a game icon (e.g., third icon 432). In some implementations, the first instance of the game 440 may be distinguished in the first messaging feed 408 by a game window 438, chat bubble, and/or by other techniques. In some implementations, the first user of the first computing platform 400 may be considered an “initiator” of the game. In some implementations, a first instance 442 of the entered and/or selected third icon 432 may be presented in the game 440. The first instance 442 of the third icon 432 may comprise a game entity associated with and/or controlled by the first user.

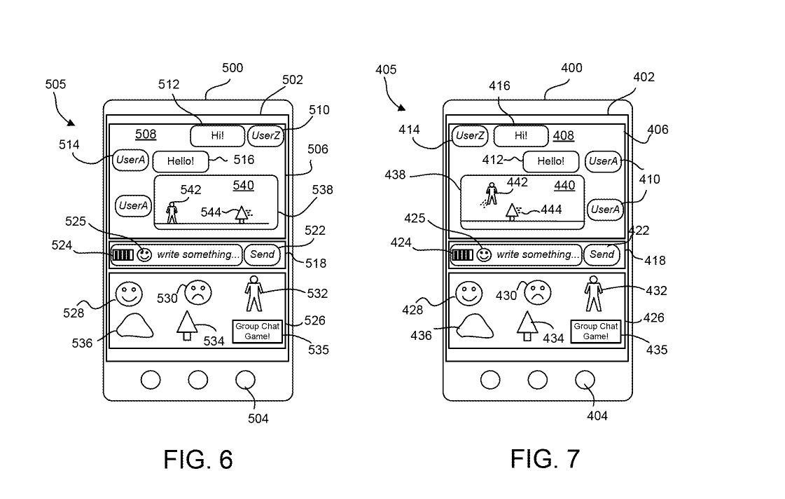

FIG. 6 illustrates an implementation of a second computing platform 500 associated with a second user (e.g., “UserZ”). The second computing platform 500 may include a second display 502 and second interface elements 504. The second computing platform 500 and first computing platform 400 may share in a communication session. A second messaging interface 505 of a messaging application may be presented on the second display 502. The second messaging interface 505 may include a second communication field 506, a second assembly field 518, a second entry field 526, and/or other fields. The second entry field 526 may be configured to display messaging content available for entry and/or selection by the second user of the second computing platform 500. In some implementations, second interface elements 524 and/or 525 of the second assembly field 518 may facilitate switching between implementations of the second entry field 526 (e.g., between keyboard type entry and/or graphical icon type entry). The second assembly field 518 may include a “send” interface element 522, and/or other features.

Graphical icons shown in the second entry field 526 may include one or more of a first icon 528, a second icon 530, a third icon 532, a fourth icon 534, a fifth icon 536, a sixth icon 535, and/or more or less icons. One or more of the graphical icons may include static icons, dynamic icons, game icons, and/or other types of graphical icons. By way of non-limiting example, the first icon 528 and second icon 530 may comprise static and/or dynamic icons (e.g., smiley faces); and the third icon 532, fourth icon 534, fifth icon 536, and sixth icon 535 may comprise game icons. In some implementations, the graphical icons shown in the second entry field 526 and available to the second user of the second computing platform 500 may be the same or similar graphical icons shown in the first entry field 426 and available to the user of the first computing platform 400 (see, e.g., FIG. 4). However, in some implementations, the graphical icons available to users may differ depending user subscription, purchases, and/or other information.

In some implementations, a second messaging feed 508 may include a first user icon 510 and/or other identification that may represent the second user (e.g., “UserZ”) of the second computing platform 500. The second messaging feed 508 may include messaging content 512 entered and/or selected by the second user of the second computing platform 500. The second messaging feed 508 may include messaging content previously entered and/or selected by one or more other users through the one or more other computing platforms. By way of non-limiting example, the second messaging feed 508 may include a second user icon 514 and/or other identification that may represent another user (e.g., first user “UserA”) of another computing platform (e.g., first computing platform 400 in FIG. 4). The second messaging feed 508 may include other messaging content 516, game window 538, and/or other messaging content entered and/or selected by the first user. In some implementations, the respective messaging content entered by users in a communication session may be represented by separate chat bubbles within the messaging feed, and/or may be distinguished in other ways.

In some implementations, the second messaging feed 508 may reflect a second instance of the game 540 corresponding to entry and/or selection by the first user (e.g., “UserA”) via the first computing platform 400. The second instance of the game 540 in the second messaging feed 508 and the first instance of the game 440 in the first messaging feed 408 of the first computing platform 400 (see, e.g., FIG. 5) may correspond to views of the game being played over a shared communication session. The second instance of the game 540 may include a second instance 542 of the third icon 432 entered by the user of the first computing platform 400. For illustrative purposes, gameplay may be carried by virtue of the user of the first computing platform 400 controlling the instances of the third icon 432 within the respective instances of the game 440, 540. By way of non-limiting example, the first user of first computing platform 400 may provide game control inputs related to moving the instances of the third game icon 432 to jump over obstacles introduced into the game. In some implementations, obstacles may be introduced into the instances of the game based on game control inputs provided by the second user via the second computing platform 500.

As shown in FIG. 6, the second user may provide game control inputs to introduce a first instance 544 of the fourth icon 534. By way of non-limiting example, the second user may select the fourth icon 534 from the second entry field 526. In the context of the current game example, the first instance 544 of the fourth icon 534 may comprise an obstacle that moves through the game that the first user must attempt to jump over via game control inputs at the first computing platform 400.

FIG. 7 illustrates a view of the first computing platform 400 showing a second instance 444 of the fourth icon 534 in the game 440 of the first messaging feed 408. The first user may provide game control inputs to control the instances of the third icon 432 to jump over obstacles. By way of non-limiting example, control inputs provided by the first user may comprise touching, tapping, swiping, providing other touch-responsive input on the display 402, and/or providing other input via the first computing platform 400.

FIG. 8 illustrates an implementation of the second computing platform 500 showing within the second instance of the game 540 that the first user successfully traversed the instance of the fourth icon 534. The second user may introduce new obstacles 546 to continue gameplay, if desired. The second user may enter and/or select messaging content. By way of non-limiting example, the second user may enter text content 513 and/or other messaging content. The text content 513 may be presented in the second messaging feed 508. The presentation of the text content 513 may cause the second instance of the game 540 presented in the second messaging feed 508 to scroll up in the feed. The second instance game 540 may continue to be played in the messaging feed 508. In some implementations, the second instance of the game 540 may time-out after a threshold time of inactivity by the first user and/or second user.

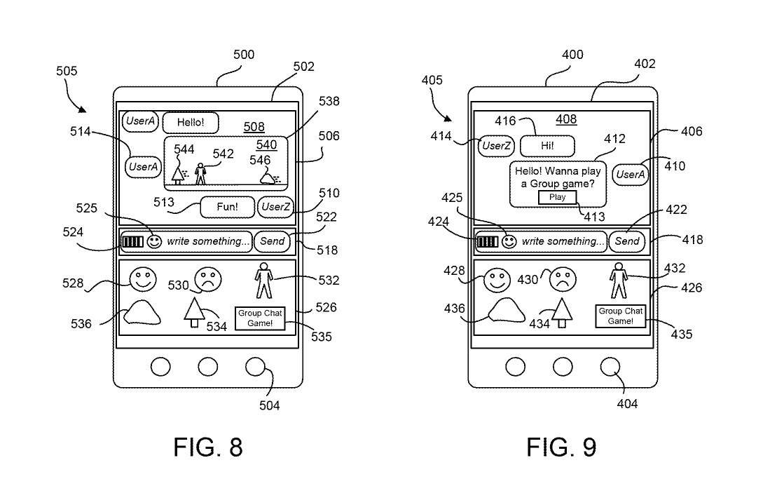

FIGS. 9-12 illustrate exemplary messaging interfaces for the first computing platform 400 and second computing platform 500 in accordance with a group gameplay event. In FIG. 9, the first messaging feed 408 of the first computing platform 400 illustrates messaging content 412 presented in the first messaging feed 408 responsive to first user entry and/or selection of the sixth game icon 435. The sixth game icon 435 may comprise, for example, a group gameplay game icon 435. The messaging content 412 may correspond to a request to initiate a group gameplay event between the first user and one or more other users sharing a communication session with the first user. The messaging content 412 and/or other instances of the messaging content (see, e.g., messaging content 516 in FIG. 11) may include an interface element 413 configured to receive user entry and/or selection of an acceptance of the request.

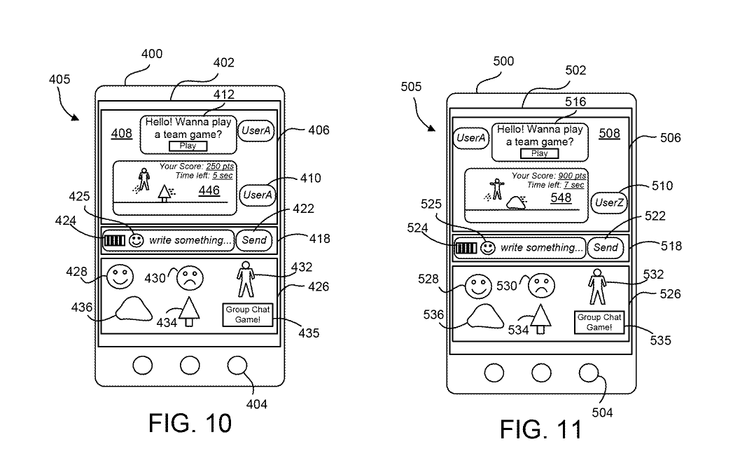

By way of non-limiting illustration in FIG. 10, responsive to at least one user accepting the group gameplay event request, a first mini-game 446 may be presented in the first messaging feed 408 of the first computing platform 400. The first mini-game 446 may be played by the first user of the first computing platform 400. By way of non-limiting example, the first mini-game 446 may be a game similar to the obstacle-jumping game described herein, and/or other type of gameplay. For example, obstacles may automatically be introduced into the game and may move across the screen. The first user may attempt to traverse them by providing game control inputs at the correct time to score points. Within the first mini-game 446, a first outcome (e.g., “your score”), a remaining time (e.g., “time left”), and/or other information may be displayed. In some implementations, a time remaining for the group gameplay event as a whole may be displayed.

FIG. 11 illustrates an exemplary second messaging interface 505 of a second computing platform 500 associated with a second user. The second user may have accepted a group gameplay request 516. As a result, a second mini-game 548 may be presented in a second messaging feed 508. The second mini-game 548 may be of a type that is the same or similar to the first mini-game 446 (FIG. 10), and/or may be a different type of game. The outcomes of the second mini-game 548, first mini-game 446 (FIG. 10), and/or other mini-games associated with users participating in shared group gameplay event may determine an outcome of the shared group gameplay event.

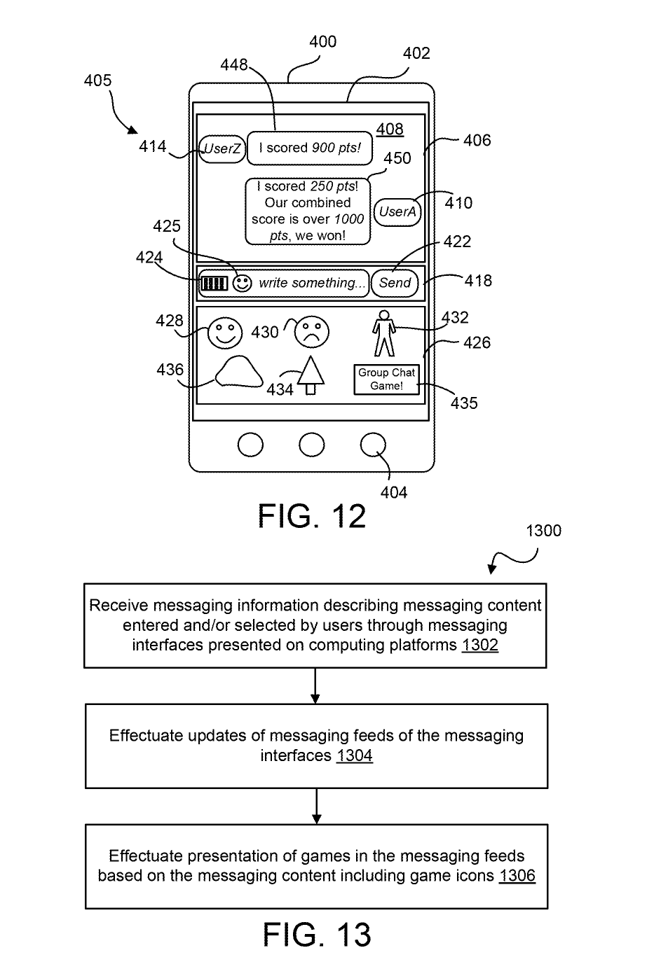

FIG. 12 illustrates an exemplary implementation of the first computing platform 400, including one or more of determined outcomes of mini-games played by users in a group, determined outcomes of a group gameplay event, and/or results from the group gameplay event in the first messaging feed 408. For example, messaging content 448 may include an outcome of participation by the second user (e.g., UserZ) in a mini-game (e.g., scored 900 points). Messaging content 450 may include one or more of an outcome of participation by the first user in a mini-game, a group gameplay outcome (e.g., combined scores), a result (e.g., exceeding the group gameplay goal), and/or other information.

The above description of gameplay within messaging feeds shown in messaging interfaces of computing platforms is not intended to be limiting. Instead, it is for illustrative purposes and should not be considered limiting with respect to the types of game and/or gameplay that may take place, the ways in which users may provide game control inputs, messaging content, graphical icons, game icons, the ways in which messaging content may be displayed in a messaging feed, the ways in which games may take place in the messaging feed, and/or with respect to other features and/or functions described herein. By way of non-limiting example, other types of gameplay may include turn-based games, skill-based games, chance-based games, multi-player games, single-player games, commerce-based games, first person shooters, puzzle games, role playing games, and/or other game types.

Returning to FIG. 1, server 102, computing platforms 118, and/or external resources 120 may be operatively linked via one or more electronic communication links. For example, such electronic communication links may be established, at least in part, via a network (e.g., network(s) 116) such as the Internet and/or other networks. It will be appreciated that this is not intended to be limiting, and that the scope of this disclosure includes implementations in which server 102, computing platforms 118, and/or external resources 120 may be operatively linked via some other communication media.

The external resources 120 may include sources of information that are outside of system 100, external entities participating with system 100, and/or other resources. In some implementations, some or all of the functionality attributed herein to external resources 120 may be provided by resources included in system 100.

Computing platforms 118 may include electronic storage 132, one or more processors 122, and/or other components. Computing platforms 118 may include communication lines or ports to enable the exchange of information with a network, a server, and/or other computing platforms. Illustration of computing platforms 118 in FIG. 1 is not intended to be limiting. Computing platforms 118 may include a plurality of hardware, software, and/or firmware components operating together to provide the functionality attributed herein to computing platforms 118.

Server 102 may include electronic storage 114, one or more processors 104, and/or other components. Server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 114 and/or 132 may comprise electronic storage media that electronically stores information. The electronic storage media of the electronic storage 114 and/or 132 may include one or both of storage that is provided integrally (i.e., substantially non-removable) with the respective device and/or removable storage that is removably connectable to the respective device. Removable storage may include, for example, a port or a drive. A port may include a USB port, a firewire port, and/or other port. A drive may include a disk drive and/or other drive. Electronic storage 114 and/or 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage 114 and/or 132 may store files, software algorithms, information determined by processor(s) 104 and/or 122, respectively, and/or other information that enables the respective devices to function as described herein.

Processor(s) 104 is configured to provide information-processing capabilities in the server 102. As such, processor(s) 104 may include one or more of a digital processor, an analog processor, a digital circuit designed to process information, an analog circuit designed to process information, a state machine, and/or other mechanisms for electronically processing information. Although the processor(s) 104 are shown in FIG. 1 as single entity within the server 102, this is for illustrative purposes only. In some implementations, the processor(s) 104 may include one or more processing units. These processing units may be physically located within the same device or may represent processing functionality of a plurality of devices operating in coordination.

For example, processor(s) 104 may be configured to execute components 106, 107, 108, 110, and/or 112. Processor(s) 104 may be configured to execute components 106, 107, 108, 110, and/or 112 by software; hardware; firmware; some combination of software, hardware, and/or firmware; and/or other mechanisms for configuring processing capabilities on processor 104. It should be appreciated that, although components 106, 107, 108, 110, and/or 112 are illustrated in FIG. 1 as being co-located within a single processing unit, in implementations in which processor 104 includes multiple processing units, one or more of components 106, 107, 108, 110, and/or 112 may be located remotely from the other components. The description of the functionality provided by the different components 106, 107, 108, 110, and/or 112 described above is for illustrative purposes and is not intended to be limiting, as any of components 106, 107, 108, 110, and/or 112 may provide more or less functionality than is described. For example, one or more of components 106, 107, 108, 110, and/or 112 may be eliminated, and some or all of its functionality may be provided by other ones of components 106, 108, 110, 112 and/or other components.

Processor(s) 122 are configured to provide information-processing capabilities in the computing platforms 118. As such, processor(s) 122 may include one or more of a digital processor, an analog processor, a digital circuit designed to process information, an analog circuit designed to process information, a state machine, and/or other mechanisms for electronically processing information. Although the processor(s) 122 are shown in FIG. 1 as a single entity within the computing platform 118, this is for illustrative purposes only. In some implementations, the processor(s) 122 may include one or more processing units. These processing units may be physically located within the same device or may represent processing functionality of a plurality of devices operating in coordination.

For example, processor(s) 122 may be configured to execute components 124, 125, 126, and/or 128. Processor(s) 122 may be configured to execute components 124, 125, 126, and/or 128 by software; hardware; firmware; some combination of software, hardware, and/or firmware; and/or other mechanisms for configuring processing capabilities on processor 122. It should be appreciated that, although components 124, 125, 126, and/or 128 are illustrated in FIG. 1 as being co-located within a single processing unit, in implementations in which processor(s) 122 includes multiple processing units, one or more of components 124, 125, 126, and/or 128 may be located remotely from the other components. The description of the functionality provided by the different components 124, 125, 126, and/or 128 described above is for illustrative purposes and is not intended to be limiting, as any of components 124, 125, 126, and/or 128 may provide more or less functionality than is described. For example, one or more of components 124, 125, 126, and/or 128 may be eliminated, and some or all of its functionality may be provided by other ones of components 124, 125, 126, 128, and/or other components.

FIG. 13 illustrates an implementation of a method 1300 of facilitating gameplay within messaging feeds of messaging applications. The operations of method 1300 presented below are intended to be illustrative. In some implementations, method 1300 may be accomplished with one or more additional operations not described and/or without one or more of the operations discussed. Additionally, the order in which the operations of method 1300 are illustrated in FIG. 13 and described below is not intended to be limiting.

In some implementations, method 1300 may be implemented in one or more processing devices (e.g., a computing platform, a digital processor, an analog processor, a digital circuit designed to process information, an analog circuit designed to process information, a state machine, and/or other mechanisms for electronically processing information) and/or one or more other components. The one or more processing devices may include one or more devices executing some or all of the operations of method 1300 in response to instructions stored electronically on an electronic storage medium. The one or more processing devices may include one or more devices configured through hardware, firmware, and/or software to be specifically designed for execution of one or more of the operations of method 1300.

At an operation 1302, messaging information describing messaging content entered and/or selected by users may be received. The users may be associated with computing platforms. Computing platforms may be associated with communication sessions. The messaging content may have been entered and/or selected by users via messaging interfaces presented at the computing platforms. In some implementations, operation 1302 may be performed by a receiving component the same as or similar to receiving component 107 (shown in FIG. 1 and described herein).

At an operation 1304, updates of messaging feeds of the messaging interfaces presented on the computing platforms may be effectuated. The updates may be based on the received messaging information. In some implementations, operation 1304 may be performed by an updating component the same as or similar to updating component 108 (shown in FIG. 1 and described herein).

At an operation 1306, presentation of games in the messaging feeds may be effectuated. The presentation of games may be based on user entry and/or selection of messaging content including game icons. In some implementations, operation 1306 may be performed by a gaming component the same as or similar to gaming component 110 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A non-transitory computer-readable storage medium having instructions embodied thereon, the instructions being executable by a computing platform including one or more physical processors to perform a method for facilitating gameplay within a messaging feed of a messaging application, the method comprising:
presenting a messaging interface, the messaging interface including an entry field and a communication field, the entry field displaying messaging content available for entry and/or selection by users, the communication field displaying a messaging feed that reflects a communication session between the computing platform and one or more other computing platforms, such presentation of the messaging feed includes messaging content previously entered and/or selected by a first user through the entry field and messaging content previously entered and/or selected by one or more other users through the one or more other computing platforms;
receiving entry and/or selection of first messaging content by the first user through the entry field;
updating the messaging feed in the communication field to present the first messaging content; and
wherein the messaging content available for entry and/or selection by the first user includes one or more game icons, wherein entry and/or selection of a game icon effectuates presentation of a corresponding game within the messaging feed presented on the computing platform, such that by virtue of the first messaging content comprising a first game icon, the updating comprises presenting a first game within the messaging feed to facilitate participation by the first user in the first game, the first game in the messaging feed comprising a first instance of the first game icon.

2. The non-transitory computer-readable storage medium of claim 1, wherein the method further comprises:
effectuating communication of information to facilitate an update of the other messaging feeds presented in messaging interfaces of the one or more other computing platforms to include the first messaging content, such that the update of other messaging feeds presented on the one or more other computing platforms includes effectuating presentation of the first game on the other messaging feeds to facilitate participation by the one or more other users in the first game via the one or more other computing platforms, such presentation of the first game on the one or more other computing platforms includes other instances of the first game icon being presented in the other messaging feeds.

3. The non-transitory computer-readable storage medium of claim 2, wherein the method further comprises:
receiving entry and/or selection of game control inputs by the first user through one or both of the entry field or the communication field of the messaging interface, the game control inputs corresponding to one or both of:
controlling the first instance of the first game icon in the messaging feed, or
introducing instances of other game icons into the first game presented on the messaging feed.

4. The non-transitory computer-readable storage medium of claim 1, wherein the method further comprises:
receiving entry and/or selection of second messaging content by the first user through the entry field; and
updating the messaging feed to reflect the second messaging content, wherein the updating includes scrolling the first messaging content from a first position in the messaging feed to a second position in the messaging feed.

5. The non-transitory computer-readable storage medium of claim 1, wherein the method further comprises:
receiving messaging information describing second messaging content entered and/or selected by a second user via a second computing platform included in the communication session; and
updating the messaging feed to reflect the second messaging content, wherein the updating comprises scrolling the first messaging content from a first position in the messaging feed to a second position in the messaging feed.

6. The non-transitory computer-readable storage medium of claim 1, wherein messaging content includes one or more of text, a graphical icon, a video, or audio, and wherein the first game icon is represented by a first graphical icon.

7. The non-transitory computer-readable storage medium of claim 1, wherein the method further comprises:
executing an instance of the first game and implementing the instance of the first game to facilitate participation by the first user in the first game; and
wherein executing the instance of the first game facilitates effectuating presentation of the first game in the messaging feed.

8. The non-transitory computer-readable storage medium of claim 1, wherein effectuating presentation of the first game is based on information received from an entity external to the computing platform.

9. A system for facilitating gameplay within messaging feeds displayed on computing platforms, the system comprising:
one or more physical processors configured by computer-readable instructions to:
receive messaging information describing messaging content entered and/or selected by users through computing platforms associated with communication sessions, the messaging content entered and/or selected by users via messaging interfaces presented at the computing platforms, including receiving first messaging information describing first messaging content entered and/or selected by a first user through a first computing platform, the first computing platform associated with a first communication session,
wherein the first computing platform is configured to present a first messaging interface, the first messaging interface including a first entry field and a first communication field, the first entry field displaying messaging content available for entry and/or selection by a first user, the first communication field displaying a first messaging feed that reflects the first communication session, such presentation of the first messaging feed including messaging content previously entered and/or selected by the first user through the first entry field and messaging content previously entered and/or selected by a second user through the second computing platform associated with the first communication session;
effectuate updates of messaging feeds of the messaging interfaces presented on the computing platforms based on the received messaging information, the updates corresponding to presenting messaging content in the messaging feeds, including effectuating a first update of a second messaging feed presented on the second computing platform based on the received first messaging information, the first update corresponding to presenting the first messaging content in the second messaging feed; and
wherein the messaging content available for entry and/or selection by the users includes one or more game icons, wherein entry and/or selection of a game icon effectuates presentation of a corresponding game within the messaging feeds presented on the computing platforms, such that by virtue of the first messaging content comprising a first game icon, the first update comprises effectuating presentation of a first game within the second messaging feed to facilitate participation by the second user in the first game, the first game in the second messaging feed including an instance of the first game icon.

10. The system of claim 9, wherein the one or more physical processors are further configured by computer-readable instructions such that responsive to receiving the first messaging information, the first game is presented in the first messaging feed, and wherein the one or more physical processors are further configured by computer-readable instructions to:
receive game update information describing entry and/or selection of a second game icon from the second user via the second computing platform; and
effectuate a second update of the first messaging feed based on the game update information, the second update corresponding to presenting an instance of the second game icon within the first game presented in the first messaging feed.

11. The system of claim 9, wherein the one or more physical processors are further configured by computer-readable instructions to:
receive game update information describing entry and/or selection of game control inputs by the users through the messaging interfaces, including receiving first game update information describing entry and/or selection of first game control input by the first user through one or both of the first entry field or the first communication field of the first messaging interface, the first game control input corresponding to one or both of:
controlling the instance of the first game icon in the second messaging feed, or
introducing instances of other game icons into the first game presented on the second messaging feed; and
effectuate updates of the messaging feeds presented on the computing platforms based on the received game update information, the updates including effectuating the game control inputs in the games presented in the messaging feeds, including effectuating a second update of the second messaging feed presented on the second computing platform by effectuating the first game control input in the first game presented in the second messaging feed.

12. The system of claim 9, wherein the one or more physical processors are further configured by computer-readable instructions such that messaging content includes one or more of text, a graphical icon, a video, or audio, and wherein the first game icon is represented in the first entry field by first graphical icon.

13. The system of claim 9, wherein the one or more physical processors are further configured by computer-readable instructions to:
execute instances of the first game and implement the instances of the first game to facilitate participation by users in the first game; and
wherein executing the instances of the first game facilitates the presentation of the first game in the second messaging.

14. A computer-implemented method of facilitating gameplay within messaging feeds of messaging applications, the method being implemented in a computer system including one or more physical processor and storage media storing computer-readable instructions, the method comprising:
receiving messaging information describing messaging content entered and/or selected by users through computing platforms associated with communication sessions, the messaging content entered and/or selected by users via messaging interfaces presented at the computing platforms, including receiving first messaging information describing first messaging content entered and/or selected by a first user through a first computing platform, the first computing platform associated with a first communication session,
wherein the first computing platform is configured to present a first messaging interface, the first messaging interface including a first entry field and a first communication field, the first entry field displaying messaging content available for entry and/or selection by a first user, the first communication field displaying a first messaging feed that reflects the first communication session, such presentation of the first messaging feed including messaging content previously entered and/or selected by the first user through the first entry field and messaging content previously entered and/or selected by a second user through the second computing platform associated with the first communication session; and
effectuating updates of messaging feeds of the messaging interfaces presented on the computing platforms based on the received messaging information, the updates corresponding to presenting messaging content in the messaging feeds, including effectuating a first update of a second messaging feed presented on the second computing platform based on the received first messaging information, the first update corresponding to presenting the first messaging content in the second messaging feed;
wherein the messaging content available for entry and/or selection by the users includes one or more game icons, wherein entry and/or selection of a game icon effectuates presentation of a corresponding game within the messaging feeds presented on the computing platforms, such that by virtue of the first messaging content comprising a first game icon, the first update comprises effectuating presentation of a first game within the second messaging feed to facilitate participation by the second user in the first game, the first game in the second messaging feed including an instance of the first game icon.

15. The method of claim 14, wherein the first game is presented in the first messaging feed, and wherein the method further comprises:
receiving game update information describing entry and/or selection of a second game icon from the second user via the second computing platform; and
effectuating a second update of the first messaging feed based on the game update information, the second update corresponding to presenting an instance of the second game icon within the first game presented in the first messaging feed.

16. The method of claim 14, further comprising:
receiving game update information describing entry and/or selection of game control inputs by the users through the messaging interfaces, including receiving first game update information describing entry and/or selection of first game control input by the first user through one or both of the first entry field or the first communication field of the first messaging interface, the first game control input corresponding to one or both of:
controlling the instance of the first game icon in the second messaging feed, or
introducing instances of other game icons into the first game presented on the second messaging feed; and
effectuating updates of the messaging feeds presented on the computing platforms based on the received game update information, the updates including effectuating the game control inputs in the games presented in the messaging feeds, including effectuating a second update of the second messaging feed by effectuating the first game control input in the first game presented in the second messaging feed.

17. The method of claim 14, wherein the messaging content includes one or more of text, a graphical icon, a video, or audio, and wherein the first game icon is represented in the first entry field by first graphical icon.

18. The method of claim 14, further comprising:
executing instances of the first game and implementing the instances of the first game to facilitate participation by users in the first game; and
wherein executing the instances of the first game facilitates the presentation of the first game in the second messaging.

19. A system for facilitating group gameplay within messaging feeds of messaging applications, the system comprising:
one or more physical processors configured by computer-readable instructions to:
receive entry and/or selection of messaging content, the messaging content associated with communication sessions between computing platforms, the messaging content entered and/or selected by users via messaging interfaces presented at the computing platforms, wherein:
the messaging content is presented in messaging feeds of the messaging interfaces, and
the messaging content includes group gameplay icons that when entered and/or selected effectuate group gameplay between users in groups;
effectuate presentation of games within the messaging feeds in accordance with group gameplay between users, such that responsive to receiving entry and/or selection of a first group gameplay icon by a first user via a first computing platform, first group gameplay is effectuated between the first user and a second user such that a first game is presented on a first messaging feed on the first computing platform, and a second game is presented on a second messaging feed on a second computing platform associated with the second user, wherein the first computing platform and second computing platform are associated with a first communication session;
determine outcomes of group gameplay based on outcomes of the games played by individual users in the groups, such that a first outcome of the first group gameplay is determined based on a second outcome of the first game played by the first user and a third outcome of the second game played by the second user; and
effectuate presentation of determined group gameplay outcomes on the messaging feeds associated with users in the groups, such that the first outcome is presented on the first messaging feed and the second messaging feed.

20. The system of claim 19, wherein the one or more physical processors are further configured by computer-readable instructions to:
effectuate presentation of outcomes of the games played by individual users in the messaging feeds based on individual ones of the users' completing gameplay within a game, such presentation including the second outcome and third outcome presented on the first messaging feed and the second messaging feed.

21. The system of claim 19, wherein the one or more physical processors are further configured by computer-readable instructions such that the outcomes of the games include scores achieved by the users during participation in the games, and wherein outcome of the group gameplay includes combined scores achieved by individual ones of the users in the games.
